(19) United States
(12) Patent Application Publication
(10) Pub. No.: US 2009/0158065 A1
(43) Pub. Date: Jun. 18, 2009

(54) IMAGE PROCESSING APPARATUS, IMAGE PROCESSING SYSTEM AND POWER CONTROL METHOD THEREOF

(75) Inventor: Byeong-woon HA, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/264,485

(22) Filed: Nov. 4, 2008

(30) Foreign Application Priority Data
Dec. 18, 2007 (KR) 2007-133449

(51) Int. Cl. G06F 1/00

(52) U.S. Cl. 713/310

(57) ABSTRACT

Provided is an image processing apparatus including a microcomputer, a standby power supply unit to supply standby power to the microcomputer, a power control port to receive an external control signal, and a power controller to supply the standby power or to cut off the standby power supplied to the microcomputer according to an external control signal if the external power control signal is supplied.

### CROSS-REFERENCE TO RELATED APPLICATIONS

This application claims priority under 35 U.S.C. §119(a) from Korean Patent Application No. 10-2007-0133449, filed on Dec. 18, 2007 in the Korean Intellectual Property Office, the disclosure of which is incorporated herein in its entirety by reference.

### BACKGROUND OF THE INVENTION

1. Field of the Invention

Apparatuses and methods consistent with the present general inventive concept relate to an image processing apparatus, an image processing system and a power control method thereof, and more particularly, to an image processing apparatus to reduce standby power consumption, an image processing system and a power control method thereof.

2. Description of the Related Art

Generally, an image processing apparatus receives and processes an image signal.

The image processing apparatus includes a display apparatus such as a TV receiving and processing a broadcasting signal and displaying an image; an electronic device such as a CD player, a DVD player and a VCR (video cassette recorder) processing an image signal of a CD, a DVD and a video cassette; and a device such as a set-top box additionally providing two way communication service as well as processing an image signal.

FIG. 1 is a block diagram illustrating a TV as a related art image processing apparatus. As illustrated therein, a related art image processing apparatus 1 includes an image processor 60 to process a received image signal; a display unit 70 to display a processed image signal thereon; a microcomputer 50 to control power supplied to the image processor 60; and a power supply unit 10 to supply power to the image processor 60 and the microcomputer 50, respectively.

The power supply unit 10 includes a normal power supply unit 18 to supply normal power so that the image processor 60 normally operates, and a standby power supply unit 15 to supply standby power at a lower level than the normal power to the microcomputer 50.

The microcomputer 50 receives the standby power as long as a user does not cut off external source power supplied to the power supply unit 10 with a power button (not illustrated) of the image processing apparatus 1. That is, if a user inputs a command through a remote controller (not illustrated), the microcomputer 50 controls the normal power supply unit 18 to supply the normal power to the image processor 60 and provides a rapid response to the user's input.

However, as the standby power is always supplied to the microcomputer 50, standby power is unnecessarily consumed. If several devices including a TV, a DVD player and a set-top box are installed instead of a single image processing apparatus, each device consumes standby power. Thus, a way of reducing the consumption of standby power is needed.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present general inventive concept provides an image processing apparatus to reduce standby power consumption, an image processing system and a power control method thereof.

The present general inventive concept also provides an image processing apparatus to enhance a user's convenience, an image processing system and a power control method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing an image processing apparatus, comprising an image processor, a microcomputer, a standby power supply unit to supply standby power to the microcomputer, a power control port to receive an external control signal, and a power controller to supply the standby power or to cut off the standby power supplied to the microcomputer according to an external control signal, if the external power control signal is received.

The power controller may supply the standby power to the microcomputer if the external control signal is not received.

The power controller may comprise a first switch to control the standby power, and a signal supply unit to supply an internal control signal to the first switch so as to supply the standby power to the microcomputer by the first switch if the external control signal is not received.

The power controller may further comprise a reverse unit to reverse the external control signal and the internal control signal to be output to a control input terminal of the first switch.

The reverse unit may comprise a second switch to control an operation of the first switch according to the external control signal and the internal control signal.

The second switch may control the operation of the first switch according to the external control signal if the external control signal is received, and wherein the second switch may control the operation of the first switch according to the internal control signal if the external control signal is not received.

The foregoing and/or other aspects and utilities of the present general inventive concept can also be achieved by providing an image processing system, comprising an image processing apparatus which comprises an image processor, a microcomputer, a standby power supply unit to supply standby power to the microcomputer, a power control port to receive an external control signal and a power controller to supply the standby power or to cut off the standby power supplied to the microcomputer according to an external control signal if the external control signal is supplied, and an external device to supply the external control signal to the power control port.

The external device may supply the external control signal to the power control port so as to supply the standby power to the microcomputer of the image processing apparatus if an input signal is received.

The external device may supply the external control signal to the power control port so as to cut off the standby power to the microcomputer of the image processing apparatus if an input signal is received.

The external device may comprise at least one of a set-top box, a DVD player, a VCR and an audio device.

The external device may include an external device standby power supply unit to supply an external device standby power to the external device, and the external device may be operable to receive an input signal which controls the external device to perform at least one of supplying the external control signal to the power control port of the image processing apparatus and controlling the external device standby power supply unit to supply the external device standby power to the external device

The foregoing and/or other aspects and utilities of the present general inventive concept can also be achieved by providing a power control method of an image processing apparatus which has an image processor and a microcomputer, the power control method comprising generating standby power to be supplied to the microcomputer, receiving an external control signal, and supplying the standby power or cutting off the standby power supplied to the microcomputer according to the external control signal if the external control signal is supplied.

The power control method may further comprise supplying the standby power to the microcomputer if the external control signal is not received.

The foregoing and/or other aspects and utilities of the general inventive concept may also be achieved by providing a image processing system including a plurality of image processing apparatuses each having an off mode, a standby mode and a normal mode, and each having a microcomputer and a power control port, and an external device, and to supply an external control signal to a power control port to at least one of the plurality of image processing apparatuses, wherein at least one of the plurality of image processing apparatuses is placed in one of the off mode, the standby mode, and the normal mode if the external control signal supplied by the external device.

The at least one of the image processing apparatuses may be placed in the standby mode based on the external control signal.

The plurality of image processing apparatuses may be operable to receive a input signal, and if a respective image processing apparatus of the plurality of image processing apparatuses receives the input signal, the input signal may control the respective image processing apparatus to be placed in one of the off mode, the standby mode, and the normal mode.

The external device may have an external device off mode, an external device standby mode and an external device normal mode, wherein the external device may be operable to receive an input signal, and wherein if the external device receives the input signal, the input signal may control the external device to be placed in one of the external device off mode, the external device standby mode and the external device normal mode.

The foregoing and/or other aspects and utilities of the general inventive concept may also be achieved by providing a computer-readable recording medium having embodied thereon a computer program to execute a method, wherein the method includes generating standby power to be supplied to a microcomputer, receiving an external control signal, and supplying the standby power or cutting off the standby power supplied to the microcomputer according to an external control signal if the external control signal is received.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a block diagram illustrating a related art display apparatus;

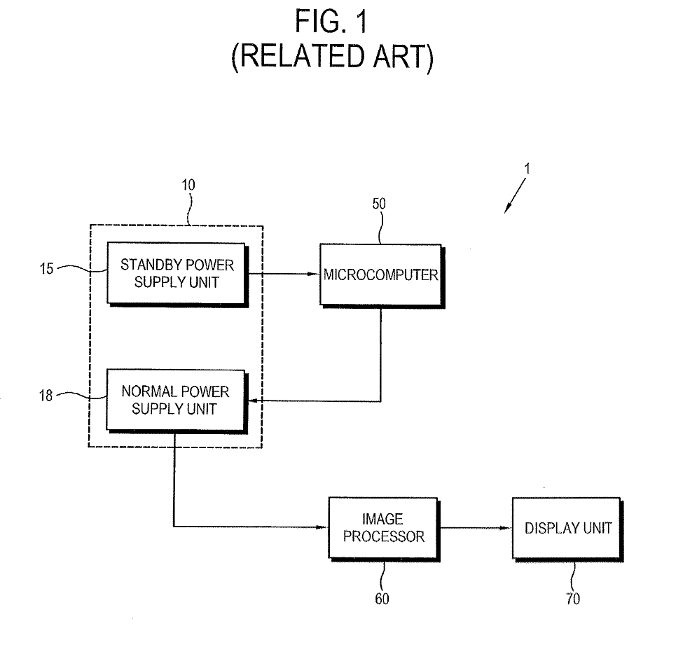

FIG. 2 illustrates an image processing system according to an exemplary embodiment of the present general inventive concept;

FIG. 3 is a block diagram illustrating the image processing system according to an exemplary embodiment of the present general inventive concept;

FIG. 4 is a block diagram illustrating an image processing system according to an exemplary embodiment of the present general inventive concept;

FIG. 5 is a block diagram illustrating an image processing system according to an exemplary embodiment of the present general inventive concept;

FIG. 6 is a block diagram illustrating an external device in FIG. 2; and

FIG. 7 is a flowchart illustrating a power control method of the image processing apparatus according to an exemplary embodiment of the present general inventive concept.

### DETAILED DESCRIPTION OF THE EXEMPLARY EMBODIMENTS

Reference will now be made in detail to exemplary embodiments of the present general inventive concept, examples of which are illustrated in the accompanying drawings, wherein like reference numerals refer to like elements throughout. The exemplary embodiments are described below so as to explain the present general inventive concept by referring to the figures.

Hereinafter, an image processing apparatus, an image processing system and a power control method thereof according to exemplary embodiments of the present general inventive concept will be described in detail with reference to accompanying drawings.

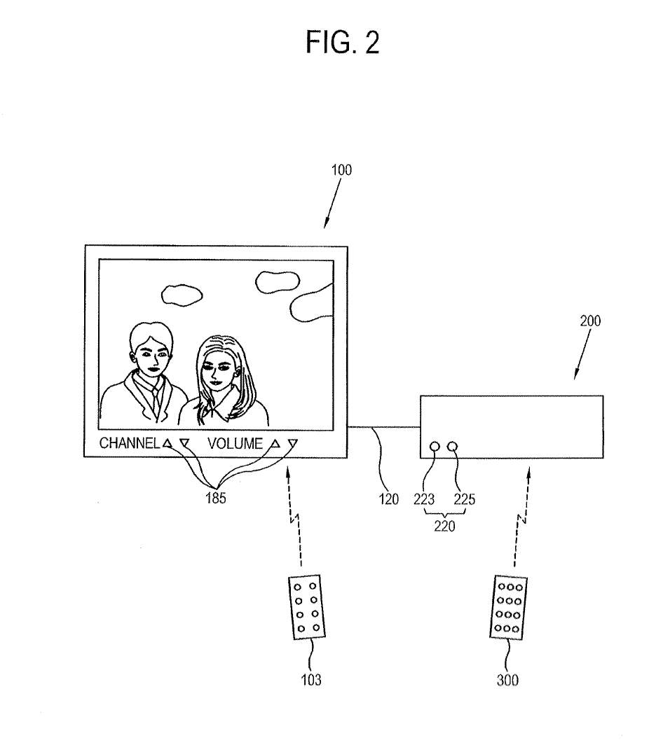

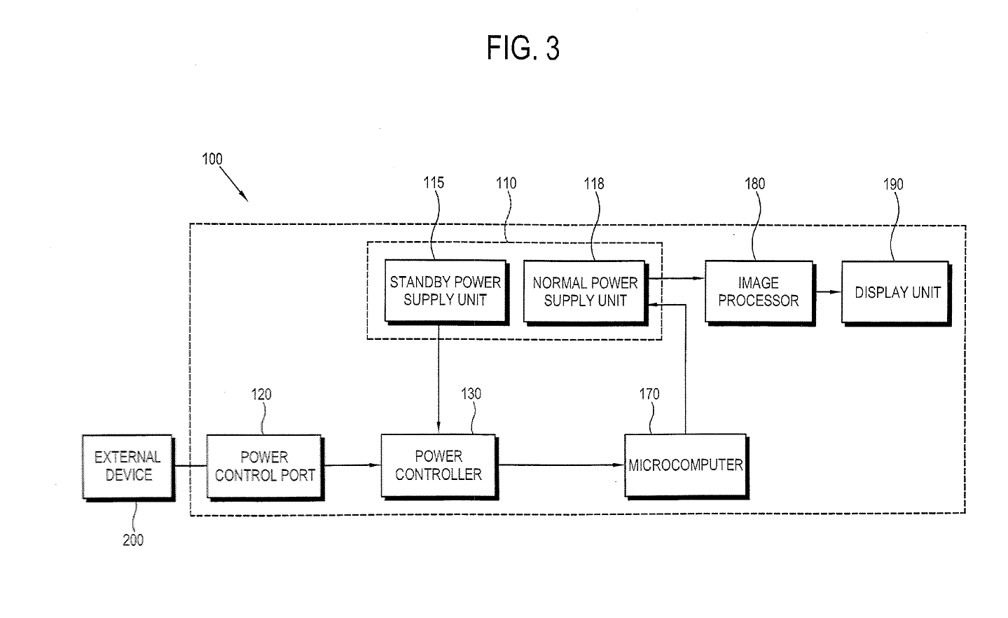

FIGS. 2 and 3 illustrate an exemplary embodiment of the present general inventive concept.

As illustrated in FIGS. 2 and 3, an image processing system according to an exemplary embodiment of the present general inventive concept includes an image processing apparatus 100 and an external device 200.

As illustrated in FIG. 3, the image processing apparatus 100 includes an image processor 180 to process an image; a microcomputer 170 to control power supplied to the image processor 180; a standby power supply unit 115 to supply standby power to the microcomputer 170; a power control port 120 to receive an external control signal from the external device 200; and a power controller 130 to control the standby power.

The image processor 180 receives and processes an image signal to generate displayable image data. If necessary, the image processing apparatus 100 may further include a display unit 190. The generated image data are displayed on the display unit 190.

The display unit 190 displays thereon image data output by the image processor 180. The display unit 190 may include a CRT (cathode ray tube), a PDP (plasma display panel), an LCD (liquid crystal display) and the like.

The standby power supply unit 115 generates standby power by using commercial power to drive the microcomputer 170. Here, the standby power has a lower voltage level than normal power (to be described later) does. Only the standby power is supplied to the microcomputer 170 in a standby mode. If a user's input is received through a remote controller 103 of the image processing apparatus 100 (to be described), the normal power is supplied to the image processor 180 so that the image processing apparatus 100 normally operates.

The normal power supply unit 118 generates normal power by using external commercial power so as to drive the image processor 180. The normal power supply unit 118, for example, is provided in the image processing apparatus 100 with the standby power supply unit 115. That is, the image processing apparatus 100 may include the power supply unit 110 having the normal power supply unit 118 and the standby power supply unit 115 therein.

The normal power supply unit 118 may supply power to other elements necessary for a normal operation of the image processing apparatus 100 except the microcomputer 170. That is, the normal power supply unit 118 supplies power to the image processor 180 as an example, and may also supply power to various other elements.

The power control port 120 receives an external control signal from the external device 200 to control the power controller 130.

If the external control signal is supplied, the power controller 130 supplies power or cuts off power supplied to the microcomputer 170 according to the external control signal.

For example, if the external control signal includes a high signal, the power controller 130 may cut off the standby power. If the external control signal is a low signal, the power controller 130 may supply the standby power. The operation of the power controller 130 according to a type of the external control signal may be opposite to that described above.

The power controller 130 may include a single switching element. The switching element may include a field effect transistor (FET), or a relay if necessary.

If the external device 200 supplies a low signal as the external control signal to the image processing apparatus 100, the microcomputer 170 of the image processing apparatus 100 does not receive the standby power, to thereby prevent consumption of the standby power. That is, if the external control signal to cut off the standby power is received from the outside, for example, the standby power is not supplied to the microcomputer 170 of the image processing apparatus 100.

The microcomputer 170 receives the standby power and controls power supplied to the image processor 180. The microcomputer 170 may control the normal power supply unit 118 to supply the normal power or cut off the normal power supplied to the image processor 180.

If the standby power is supplied and a user's input is received through the remote controller 103 of the image processing apparatus 100 or an input key 185 provided in a front surface of the image processing apparatus 100, the microcomputer 170 may control the normal power supply unit 118 to supply power to the image processor 180. Thus, an image which is processed by the image processor 180 may be displayed on the display unit 190. Here, the input key 185 may include an input button to select channels or to adjust volume.

The image processing apparatus 100 may further include a user input detector (not illustrated) which detects a user's input supplied through the input key 185 or the remote controller 103 of the image processing apparatus 100 and outputs a detection result to the microcomputer 170. The user input detector may receive and determine an input signal corresponding to the input key 185 or the remote controller 130 of the image processing apparatus 100. This process is known in the art and detailed description will be avoided.

If the user's input is not supplied, the microcomputer 170 may control the normal power supply unit 118 not to supply the normal power to the image processor 180 even if the standby power is supplied.

The determination whether to supply the normal power to the image processor 180 may be based on various other standards.

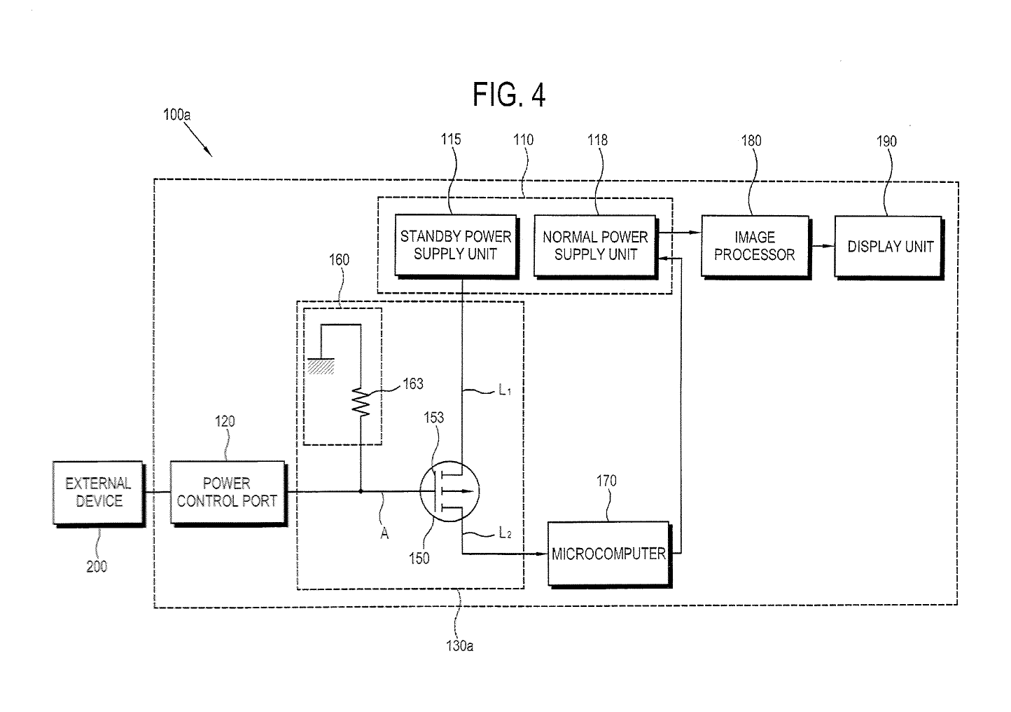

FIG. 4 illustrates another exemplary embodiment of the present general inventive concept.

As illustrated in FIG. 4, an image processing system according to this exemplary embodiment of the present general inventive concept includes an image processing apparatus 100a and an external device 200.

A power controller 130a may include a first switch 150 which is provided in power supply lines L1 and L2 between a standby power supply unit 115 and a microcomputer 170 and opens or closes the power supply lines L1 and L2 according to an external control signal.

The power controller 130a further includes a signal supply unit 160 to supply an internal control signal to the first switch 150 to thereby supply the standby power or cut off the standby power supplied to the microcomputer 170 if the external device 200 does not supply the external control signal.

The first switch 150 may include a switching element which closes the power supply lines L1 and L2 when a control input of a gate terminal 153 is high, and opens the lines L1 and L2 when the control input of the gate terminal 153 is low.

The first switch 150 may include a switching element to close the power supply lines L1 and L2 when the control input of the gate terminal 153 is low, and to open the lines L1 and L2 when the control input of the gate terminal 153 is high. In this case, the external control signal may include a high signal to cut off the standby power supplied to the microcomputer 170.

As illustrated therein, the signal supply unit 160 may include a pull-down resistor 163 which is connected to a ground line to supply a low signal as a default to the first switch 150.

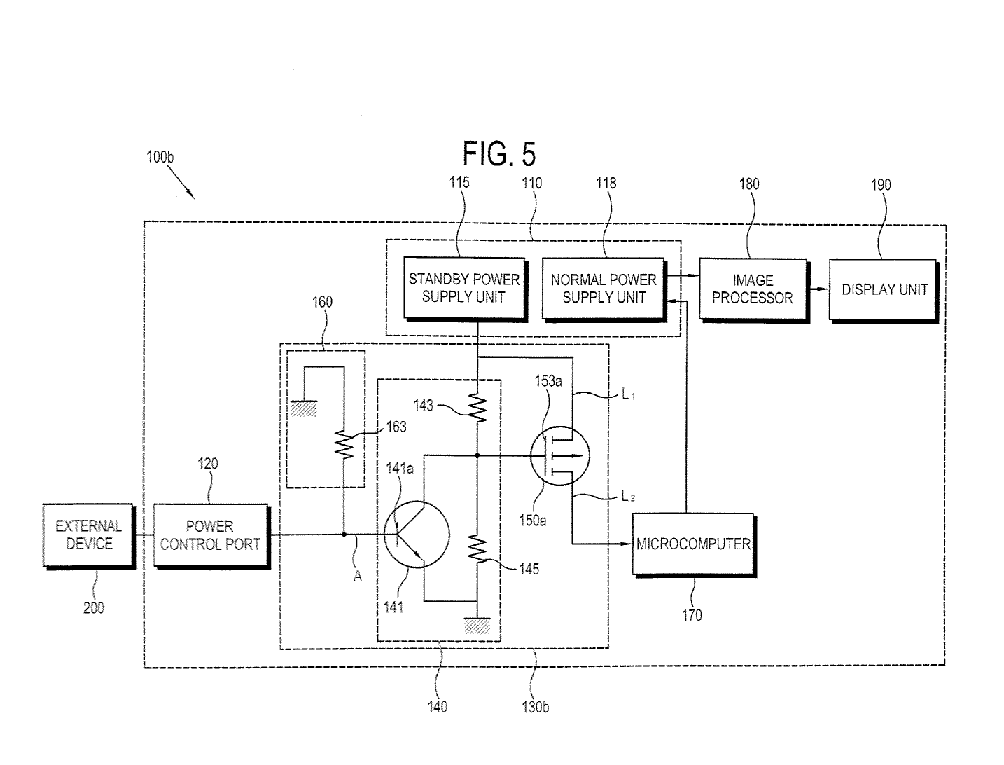

According to the exemplary embodiment illustrated in FIG. 4, a reverse unit 140 is not provided. However, a reverse unit 140 is provided in another exemplary embodiment of the present general inventive concept illustrated in FIG. 5. In the exemplary embodiment of FIG. 4, a common signal line A is directly connected to a gate terminal 153 of the first switch 150 and receives a signal from the power control port 120 and the signal supply unit 160.

If the external device 200 is connected to the power control port 120 and the external control signal input through the power control port 120 is high, the first switch 150 closes the power supply lines L1 and L2 and supplies the standby power to the microcomputer 170. If the external control signal is low, the first switch 150 opens the power supply lines L1 and L2 and cuts off the standby power. Here, the first switch 150 is a switching element to close and open the power supply lines L1 and L2 when the gate terminal 153 is at high and low levels.

Meanwhile, if the external device 200 is not connected to the power control port 120 and the signal supply unit 160 supplies a low signal as a default, the gate terminal 153 of the first switch 150 receives a low signal and the standby power is cut off.

Otherwise, the signal supply unit 160 may supply a high signal as a default to the gate terminal 153 of the first switch 150. Then, if the external device 200 is not connected to the power control port 120, the standby power as a default may be supplied to the microcomputer 170. As a result, if a user's input is supplied through the input key 185 of the image processing apparatus 100 or through the remote controller 103, even though the external device 200 does not exist, the microcomputer 170 may control the normal power supply unit 118 to supply the normal power to the image processor 180.

FIG. 5 illustrates still another exemplary embodiment of the present general inventive concept.

As illustrated in FIG. 5, an image processing system according to this exemplary embodiment of the present general inventive concept includes an image processing apparatus 100b and an external device 200.

A power controller 130b of the image processing apparatus 100 according to the present exemplary embodiment may further include a reverse unit 140. That is, as illustrated therein, the power controller 130b may include a signal supply unit 160, the reverse unit 140 and a first switch 150.

If the external device 200 is not connected to a power control port 120, the signal supply unit 160 may supply an internal control signal to the first switch 150a to close or open power supply lines L1 and L2.

If the external device 200 is not connected to the power control port 120, the internal control signal, for example, is supplied to the first switch 150a to close the power supply lines L1 and L2 and to supply standby power to the microcomputer 170. If a user's input is supplied through a remote controller 103 or an input key 185 of the image processing apparatus 100b, normal power may be supplied to the image processor 180.

The reverse unit 140 receives the standby power as a bias voltage from a standby power supply unit 115, and reverses a signal input through a common signal line A to be output to a gate terminal 153 of the first switch 150a, i.e., to a control input terminal.

The reverse unit 140 includes first and second distribution resistors 143 and 145 which are connected to in series to the standby power supply unit 115. The reverse unit 140 further includes a second switch 141 to output one of a distribution voltage or a ground voltage of the standby power applied to the second distribution resistor 145, to the gate terminal 153a of the first switch 150a according to a signal input through the common signal line A.

If a high signal is input to a base terminal 141a of the second switch 141, the gate terminal 153a of the first switch 150a is in a low level. If a low signal is input, the gate terminal 153a of the first switch 150a is in a high level. Thus, the first switch 150a opens or closes the power supply lines L1 and L2. That is, the second switch 141 controls an operation of the first switch 150a according to the external control signal and the internal control signal.

If a high signal is applied to the gate terminal 153a, the first switch 150a closes the power supply lines L1 and L2, which are lines supplying standby power generated by the standby power supply unit 115 to the microcomputer 170. If a low signal is applied to the gate terminal 153a, the first switch 150a opens the power supply lines L1 and L2.

If the external device 200 is connected to the power control port 120, an external control signal input through the power control port 120 is reversed by the reverse unit 140. Then, according to the reversed external control signal, the first switch 150a supplies the standby power or cuts off the standby power supplied to the microcomputer 170.

If the external device 200 is not connected to the power control port 120, an internal control signal supplied by the signal supply unit 160 is reversed by the reverse unit 140. According to the reversed internal control signal, the first switch 150a controls the standby power.

Hereinafter, a process of controlling the standby power according to the external and internal control signals will be described.

Referring to FIG. 5, if a low signal as an external control signal is input through the power control port 120, the low signal is reversed to a high signal by the reverse unit 140. The first switch 150 then closes the power supply lines L1 and L2 according to the high signal. The standby power is supplied to the microcomputer 170.

If a high signal as an external control signal is input, the high signal is reversed to a low signal by the reverse unit 140. The first switch 150 opens the power supply lines L1 and L2 according to the low signal. The standby power is not supplied to the microcomputer 170.

If the external control signal is not supplied, a low signal as a default is applied to the base terminal 141a of the first switch 150 by the signal supply unit 160. The low signal is then reversed to a high signal by the reverse unit 140 to be applied to the gate terminal 153 of the first switch 150. The standby power is supplied to the microcomputer 170.

The external control signal is generally not supplied when the external device 200 is not connected to the power control port 120. In some cases, however, the external control signal may not be supplied even though the external device 200 is connected to the power control port 120.

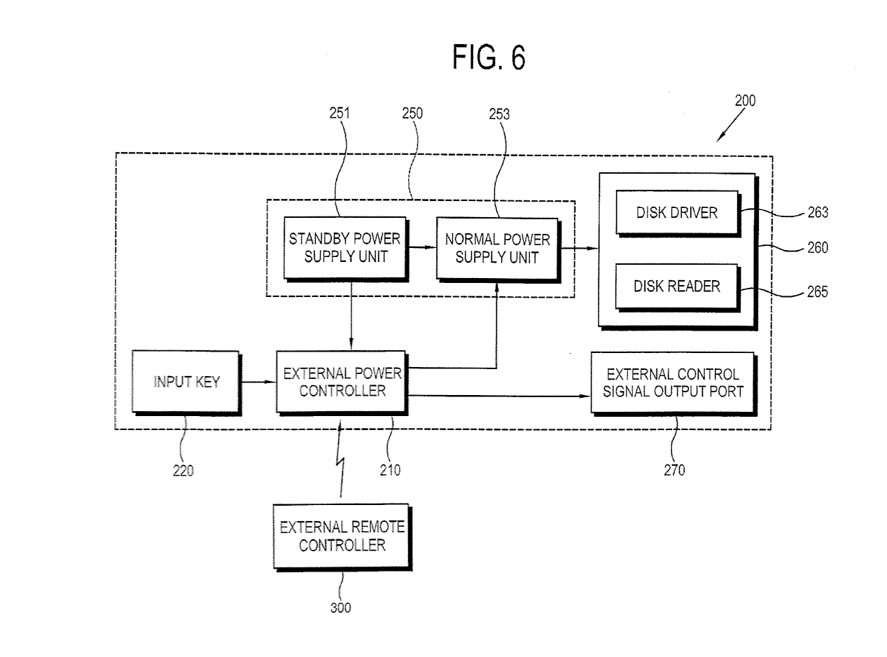

As illustrated in FIG. 6, the external device 200 of the image processing system according to an exemplary embodiment of the present general inventive concept includes an external power controller 210, a power supply unit 250 and an external control signal output port 270.

The power supply unit 250 may include a standby power supply unit 251 and a normal power supply unit 253.

The standby power supply unit 251 generates standby power to drive the external power controller 210. The normal power supply unit 253 generates normal power to drive an external image processor 260 (to be described later). Here, a standby mode refers to a mode in which only the standby power is supplied to the external power controller 210 and the normal power is not supplied to units performing main functions of the external device 200 like the external image processor 260.

If a user's input is supplied through an external remote controller 300 (refer to FIG. 2) or external input keys 223 and 225 (refer to FIG. 2), the standby power, for example, is supplied to generate an external control signal by the external power controller 210. If a user presses a power button 223 of the external input keys 223 and 225 to turn off the external device 200, the standby power may not be supplied to the external power controller 210.

The external power controller 210 outputs an external control signal to the external control signal output port 270 to control the power controller 130 of the image processing apparatus 100.

If a user's input is supplied through the external remote controller 300 or the external input key 225, the external power controller 210 may output an external control signal to the external control signal output port 270 to thereby supply standby power to the microcomputer 170 of the image processing apparatus 100. In the image processing apparatus 100 including the reverse unit 140, a low signal as an external control signal may be output to the external control signal output port 270 so that the first switch 150a closes the power supply lines L1 and L2. If one of the image processing apparatuses is in the standby mode, other connected apparatuses (image processing apparatuses 100, 100a and 100b) may be changed to the standby mode from an off mode by manipulating the remote controller. Thus, a user may use a remote controller 103 of other apparatuses. As a user does not need to press a power button of the concerned apparatus to use the remote controller in the off mode, the user's conveniences may be enhanced.

The output external control signal is transmitted to the power control port 120 of the image processing apparatus 100 through the external control signal output port 270. The external control signal output port 270 and the power control port 120 may communicate with each other in a wired or wireless manner.

If a user's input is not supplied for predetermined time in the standby mode through the external remote controller 300 or the external input key 225, the external control signal may be output to the external control signal output port 270 not to supply the standby power to the microcomputer 170 of the image processing apparatus 100. In the image processing system in which a plurality of apparatuses are connected to each other, one of the plurality of apparatuses, e.g., only the external device 200, may be changed to a standby mode and the remaining apparatuses, e.g., the image processing apparatus 100, may not supply the standby power to the microcomputer 170. Thus, consumption of the standby power is sharply reduced compared to a situation where each of the plurality of apparatuses is in the standby mode.

The external device 200 may further include an external image processor 260. As illustrated in FIG. 6, the external image processor 260 may include a disk driver 263 to drive a disk such as a CD or a DVD, and a disk reader 265 to read an image signal of the disk. That is, the external device 200 may include a CD player or a DVD player.

The external device 200 may further include at least one of a set-top box, a divX (digital Internet video express) player and an audio device. The external device 200 may vary as long as the external device 200 can be connected to the image processing apparatus 100.

The external device 200 may further include an input key 220 to receive an input from a user. The input key 220 may include a power button 223, and an input button 225 to receive a command to thereby set channels, volume and other menus and to play a disk.

If a user presses the power button 223 of the input key 220 to turn off the external device 200, the external power controller 210 may output the external control signal to the external control signal output port 270 not to supply standby power to the microcomputer 170 of the image processing apparatus 100. Thus, if a user presses the power button 223 of the external device 200 to cut off power supplied to the external device 200, the standby power of the image processing apparatus 100 may also be cut off from being supplied to the microcomputer 170. A user does not need to press the power button of each apparatus to reduce standby power consumption of apparatuses of the image processing system. Instead, if the power button of one apparatus is pressed, the standby power of other connected apparatuses is not consumed and user's conveniences are enhanced.

If a user presses the power button 223 of the external device 200 to turn on the external device 200, the external power controller 210 may output the external control signal to the external control signal output port 270 to supply the standby power to the microcomputer 170 of the image processing apparatus 100. Thus, if the power button 223 of the external device 200 is pressed to turn on the external device 200, the standby power is applied to the microcomputer 170 of the image processing apparatus 100 and the image processing apparatus 100 may be turned into a standby mode. A user may manipulate the remote controller 103 of the image processing apparatus 100 to operate the image processing apparatus 100 without directly pressing the power button 223 of the image processing apparatus 100.

If necessary, the external control signal to supply the standby power to the microcomputer 170 of the image processing apparatus 100 may be generated by pressing the input button 225 (e.g. DVD play button or a CD play button) or manipulating the external remote controller 300 other than by pressing the power button 223.

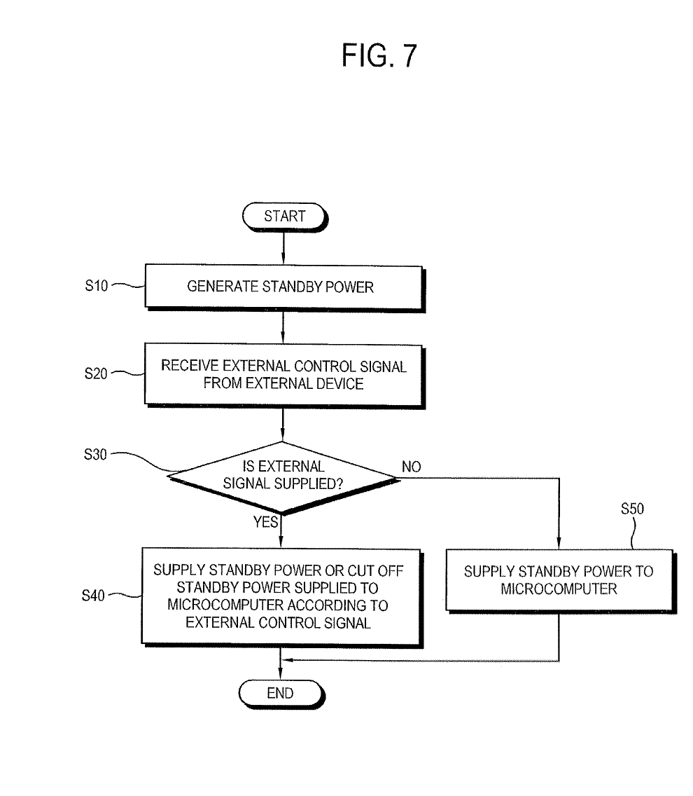

Hereinafter, a power control method of the image processing apparatuses 100, 100a and 100b according to an exemplary embodiment of the present general inventive concept will be described with reference to FIGS. 5 and 7.

The standby power is generated to be supplied to the microcomputer 170 (operation S10). The external control signal is then received from the external device 200 (operation S20). The operations S10 and S20 may be oppositely performed.

If the external control signal is supplied (operation S30), the standby power is supplied to the microcomputer 170 or cut off from being supplied to the microcomputer 170 according to the external control signal (operation S40).

If the external control signal is not supplied (operation S30), the standby power is supplied to the microcomputer 170 (operation S50). If the external control signal is not supplied (operation S30), the standby power may not be supplied to the microcomputer 170 as a default. The operation S50 may be omitted.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit information (e.g., wired or wireless data transmission through the Internet). Also, functional programs, codes, and code segments to accomplish the present general inventive concept can be easily construed by programmers skilled in the art to which the present general inventive concept pertains.

The image processing apparatus according to various exemplary embodiments of the present general inventive concept provides following effects.

First, as a control signal to control standby power is supplied by an external device, standby power consumption of the image processing apparatus may be reduced.

Second, in an image processing system in which a plurality of apparatuses is connected to each other, one of the plurality of apparatuses may be in a standby mode and others may be in an off mode not receiving power. Thus, standby power consumption may be reduced.

Third, in an image processing system in which a plurality of apparatuses is connected to each other, one device which is in a standby mode is used to change the other connected apparatuses from an off mode to a standby mode. Thus, user's conveniences are enhanced.

Although various exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An image processing apparatus comprising:
a microcomputer;
a standby power supply unit to supply standby power to the microcomputer;
a power control port to receive an external control signal; and
a power controller to supply the standby power, or to cut off the standby power supplied to the microcomputer according to the external control signal, if the external power control signal is received.

2. The image processing apparatus according to claim 1, wherein the power controller supplies the standby power to the microcomputer if the external control signal is not received.

3. The image processing apparatus according to claim 2, wherein the power controller comprises:
a first switch to control the standby power; and
a signal supply unit to supply an internal control signal to the first switch so as to supply the standby power to the microcomputer by the first switch if the external control signal is not received.

4. The image processing apparatus according to claim 3, wherein the power controller further comprises:
a reverse unit to reverse the external control signal and the internal control signal to be output to a control input terminal of the first switch.

5. The image processing apparatus according to claim 4, wherein the reverse unit comprises:
a second switch to control an operation of the first switch according to the external control signal and the internal control signal.

6. The image processing apparatus according to claim 5, wherein the second switch controls the operation of the first switch according to the external control signal if the external control signal is received, and wherein the second switch controls the operation of the first switch according to the internal control signal if the external control signal is not received.

7. An image processing system comprising:
an image processing apparatus including an image processor, a microcomputer, a standby power supply unit to supply standby power to the microcomputer, a power control port to receive an external control signal and a power controller to supply the standby power or to cut off the standby power supplied to the microcomputer according to the external control signal, if the external control signal is received; and
an external device to supply the external control signal to the power control port.

8. The image processing system according to claim 7, wherein the external device supplies the external control signal to the power control port so as to supply the standby power to the microcomputer of the image processing apparatus if an input signal is received.

9. The image processing system according to claim 7, wherein the external device supplies the external control signal to the power control port so as to cut off the standby power to the microcomputer of the image processing apparatus if an input signal is received.

10. The image processing system according to claim 7, wherein the external device comprises:
at least one of a set-top box, a DVD player, a VCR and an audio device.

11. The image processing system according to claim 7, wherein the external device includes an external device standby power supply unit to supply an external device standby power to the external device, and the external device is operable to receive an input signal which controls the external device to perform at least one of supplying the external control signal to the power control port of the image processing apparatus and controlling the external device standby power supply unit to supply the external device standby power to the external device.

12. A power control method of an image processing apparatus which has an image processor and a microcomputer, the power control method comprising:
generating standby power to be supplied to the microcomputer;
receiving an external control signal; and
supplying the standby power or cutting off the standby power supplied to the microcomputer according to the external control signal, if the external control signal is supplied.

13. The power control method according to claim 12, further comprising:
supplying the standby power to the microcomputer if the external control signal is not received.

14. An image processing system comprising:
a plurality of image processing apparatuses each having an off mode, a standby mode and a normal mode, and each having a microcomputer and a power control port; and
an external device to supply an external control signal to a power control port of at least one of the plurality of image processing apparatuses,
wherein the at least one of the plurality of image processing apparatuses is placed in one of the off mode, the standby mode, and the normal mode if the external control signal is supplied by the external device to the power control port of the at least one of the plurality of image processing apparatuses.

15. The system of claim 14, wherein the at least one of the image processing apparatuses is placed in the standby mode based on the external control signal.

16. The system of claim 14, wherein each of the plurality of image processing apparatuses is operable to receive a input signal, and if a respective image processing apparatus of the plurality of image processing apparatuses receives the input signal, the input signal controls the respective image processing apparatus to be placed in one of the off mode, the standby mode, and the normal mode.

17. The system of claim 14, wherein the external device has an external device off mode, an external device standby mode and an external device normal mode, wherein the external device is operable to receive an input signal, and wherein if the external device receives the input signal, the input signal controls the external device to be placed in one of the external device off mode, the external device standby mode and the external device normal mode.

18. A computer-readable recording medium having embodied thereon a computer program to execute a method, wherein the method comprises:
generating standby power to be supplied to a microcomputer;
receiving an external control signal; and
supplying the standby power or cutting off the standby power supplied to the microcomputer according to the external control signal, if the external control signal is received.
